(19) United States
(12) Patent Application Publication
(10) Pub. No.: US 2010/0027967 A1
(43) Pub. Date: Feb. 4, 2010

(54) INFORMATION PROCESSING DEVICE, METHOD THEREOF, PROGRAM THEREOF, RECORDING MEDIUM CONTAINING THE PROGRAM, REPRODUCTION DEVICE FOR DJ, REPRODUCTION DEVICE

(76) Inventor: Takao Yamada, Saitama (JP)

Correspondence Address: KRATZ, QUINTOS & HANSON, LLP, 1420 K Street, N.W., Suite 400, WASHINGTON, DC, 20005, US

(21) Appl. No.: 12/279,584

(22) PCT Filed: Jan. 15, 2007
(86) PCT No.: PCT/JP2007/050385

§ 371 Date: Feb. 3, 2009

(30) Foreign Application Priority Data
Feb. 16, 2006 (JP) 2006-039412

(51) Int. Cl. H04N 7/26; H04N 5/95

(52) U.S. Cl. 386/85; 386/97; 386/E05.028; 386/E05.037

(57) ABSTRACT

An information processing device discriminates a broadcast format of contents including video contents, discriminates a broadcast format valid during reproduction on the display unit, and when a data format of the contents and a data format of the display unit are different, modifies a decoding speed of the broadcast format of the contents so that a reproduction speed is modified to correspond to the broadcast format in the display unit. A simplified arrangement is obtained with an easy processing. Smooth reproduction is easily obtained by simply sequentially decoding frames of the video contents at a certain reproduction speed.

### TECHNICAL FIELD

The present invention relates to an information processing device for processing information in different formats, a method of processing information in different formats, a program for the same, a recording medium on which the program is recorded, a DJ playback device, and a reproducing device.

### BACKGROUND ART

Conventionally, a recording device that records image data such as video image information is recorded on a recording medium such as a hard disk (HDD: Hard Disk Drive) and an optical disc so that the data can be read out has widely been used. An arrangement is known, in which, in the case image data such as video image data recorded on a recording medium is reproduced, still images that are each selected to represent what each of a plurality of image data recorded in advance contains are listed on a display device (see, e.g., Patent Document 1).

According to an arrangement disclosed in Patent Document 1, image data in the so-called PAL (Phase Alternation by Line), which is a color television format different from the so-called NTSC (National Television System Committee) format which is a color television format determined by the National Television System Committee of the United States, is displayed on a liquid crystal panel for displaying image data in the NTSC format while line skipping is adopted to a display area of the liquid crystal panel.

Patent Document: JP-A-2002-218285 (page 3, left column—page 5, left column, FIG. 2)

### DISCLOSURE OF THE INVENTION

### Problems to Be Solved by the Invention

A situation where image data recorded on a recording medium is displayed on a display device that employs a different format will be discussed below. In the case image data recorded in different formats is to be displayed on a display device, for example, as described in Patent Document 1, image data in the PAL format undergoes line skipping for each display area where the data is displayed in the NTSC format. Furthermore, an interpolation processing in which new frames are added between the frames may be considered to change video frames in the PAL format associated with a data structure for reproducing in 25 frames per second to the NTSC format for reproducing 30 frames per second. If the formats are involved in a reversed manner, the processing in a reversed manner may be considered.

However, if the line skipping or the interpolation processing of image data is conducted in display areas of a display device, particularly if the consecutive image data such as video data is sequentially displayed, processing becomes cumbersome and the arrangement becomes complicated, thereby hindering reproduction of smooth video image.

In view of the above circumstances, an object of the invention is to provide an information processing device that allows smooth reproduction with a simple arrangement regardless of difference in formats of contents, a method thereof, a program thereof, a recording medium on which the program is recorded, a DJ playback device, and a reproducing device.

### Means for Solving the Problems

An information processing device according to an aspect of the invention is an information processing device that can be connected to a display device and processes contents data containing video contents to enable reproduction, including: a contents data retrieving unit that retrieves the contents data; a data format discriminating unit that discriminates a data format of the contents data; an output format discriminating unit that discriminates a data format of the display device; and a processing unit that, when the data format of the contents data is recognized to be different from the data format in the display device, converts a reproduction speed of the retrieved contents data to correspond to the data format in the display device before outputting to the output unit.

A DJ playback device according to another aspect of the invention is a DJ playback device that processes contents data that contains video contents to enable reproduction by an output unit that includes a display unit, including: a manipulation unit that comprises a manipulation element provided rotatable by a rotation manipulation and outputs a manipulation signal that corresponds to manipulation of the manipulation element; a processing unit that changes, based on the manipulation signal, the reproduction speed valid during reproduction of the video contents in the display device to output to the output unit; a contents data retrieving unit that retrieves the contents data; a data format discriminating unit that discriminates a data format of the contents data; and an output format discriminating unit that discriminates a data format valid during reproduction in the display device of the output unit, in which when the data format of the contents data is recognized to be a data format different from the data format in the display device, the processing unit converts a reproduction speed of the retrieved contents data to correspond to the data format in the display device before outputting to the output unit.

An information processing method according to still another aspect of the invention is an information processing method that processes, via a calculating unit, contents data that contains video contents to enable reproduction by an output unit that includes a display unit, in which the calculating unit conducts a contents data retrieving step that retrieves the contents data, a data format discriminating step that discriminates a data format of the contents data, an output format discriminating step that discriminates a data format valid during reproduction in the display device of the output unit, and a processing step that, when the data format of the contents data is recognized to be different from the data format in the display device, converts a reproduction speed of the retrieved contents data to correspond to the data format in the display device before outputting to the output unit.

An information processing program according to still another aspect of the invention operates a calculating unit as an information processing device or a DJ playback system according to the above-mentioned aspects of the invention.

A recording medium according to still another aspect of the invention is a recording medium on which an information processing program is recorded, in which the information processing program according to the above-mentioned aspect is recorded on the recording medium in a manner capable of being read out by a calculating unit.

A reproducing device according to still another aspect of the invention includes an output unit that comprises a display device; and an information processing device according to the above-mentioned aspect of the invention that processes contents data, which contains video contents, so that the contents data can be reproduced by the output unit or a DJ playback device according to the above-mentioned aspect of the invention that processes contents data, which contains video contents, so that the contents data can be reproduced by the output unit.

### BRIEF DESCRIPTION OF DRAWINGS

FIG. 1 is a block diagram showing a schematic arrangement of a reproducing system according to an embodiment of the invention.

FIG. 2 is a plan view showing an information processing device that forms the reproducing system of the embodiment.

FIG. 3 is a block diagram showing a schematic arrangement of an information processing unit of the information processing device of the embodiment.

FIG. 4 is a flowchart showing an operation of a reproducing process of contents in the information processing device of the embodiment.

### EXPLANATION OF CODES

100 . . . reproducing device in the form of reproducing system

200 . . . output unit

220 . . . display device in the form of display unit

300 . . . DJ playback device in the form of information processing device

340 . . . manipulation unit in the form of switch section

400 . . . calculating unit that also functions as information processing device in the form of information processing unit

420 . . . information retrieving unit that functions as contents data retrieving unit, data format discriminating unit, and output format discriminating unit

450 . . . processing unit

500 . . . manipulation unit in the form of switching device

### BEST MODE FOR CARRYING OUT THE INVENTION

Arrangement of Reproducing System

An embodiment of the invention will be described below with reference to the drawings.

In the embodiment, a reproducing device in the form of a reproducing system that audibly and visually reproduces contents including audio data that is audio contents and video data that is video contents, which exemplify the contents data, will be shown as an example. Note that this does not limit the scope of the invention. For example, contents formed only by video data, or contents including video data and text data may be reproduced. In addition, regarding the contents, an arrangement in which contents recorded on a recording medium is reproduced will be shown as an example. Nevertheless, in the case of receiving, for example, contents via a tuner, network such as the Internet, an effect similar to the above may be obtained by employing an arrangement which includes temporarily storing in a storage medium. In addition, an information processing device will be exemplified in the form of a DJ playback device. Nevertheless, the invention may be applied to a variety of arrangements. An example is an audio device, which may be for home use or for business use. Another example is an arrangement in which an output device such as a television device is integrated.

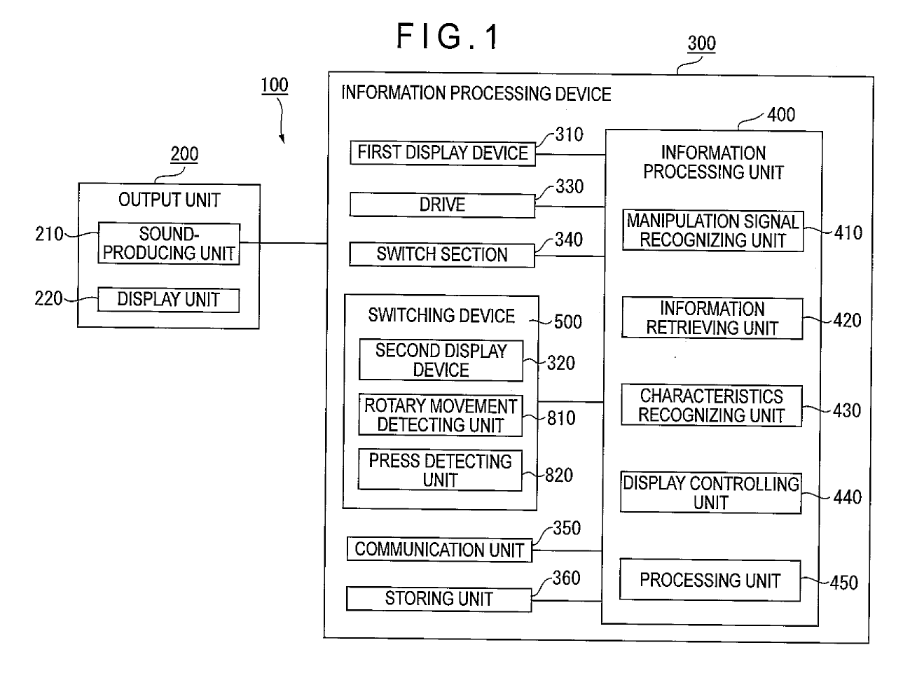

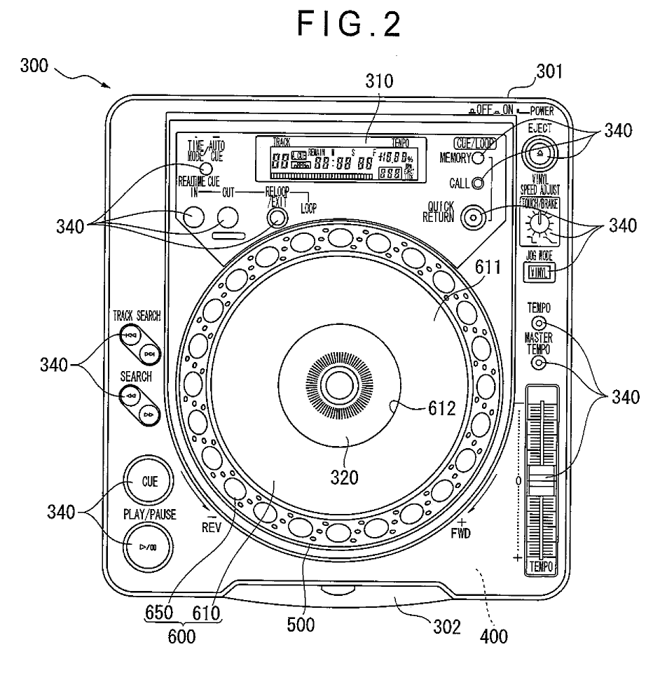

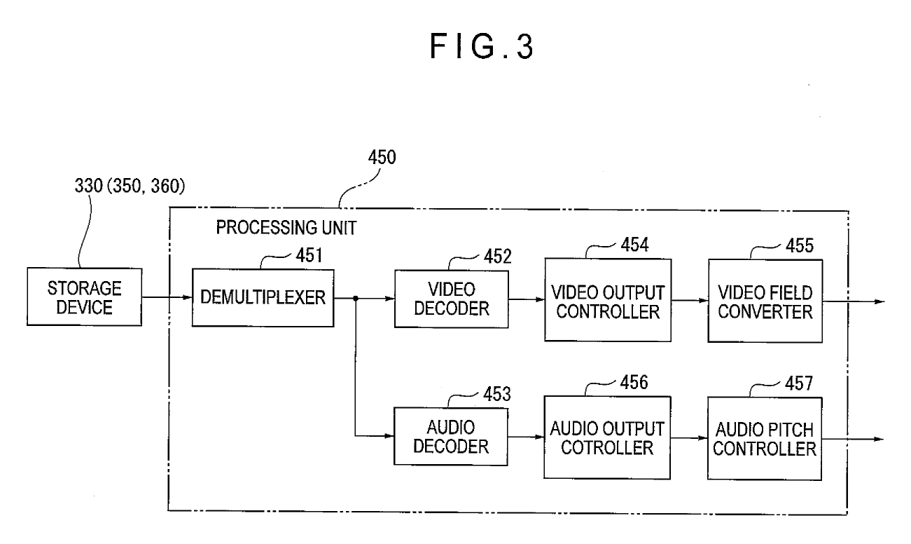

FIG. 1 is a block diagram showing a schematic arrangement of a reproducing system according to the reproducing device of the invention. FIG. 2 is a plan view showing an information processing device that forms the reproducing system. FIG. 3 is a block diagram showing a schematic arrangement of an information processing unit of the information processing device in the form of the calculating unit.

In FIG. 1, 100 is the reproducing system. The reproducing system 100 reproduces contents in the form of audio data related to sounds and music and in the form of video data related to image and video image.

The reproducing system 100 includes an output unit 200 and an information processing device 300.

The output unit 200 outputs sounds and music, or images and video images, based on signals outputted from the information processing device 300. The output unit 200 includes a sound-producing unit 210 and a display unit 220. The sound-producing unit 210 includes a speaker (not shown). When the sound-producing unit 210 obtains a signal corresponding to audio data from the information processing device 300, for example, the sound-producing unit 210 suitably conducts processing such as amplification, and outputs the signal from the speaker in a sound-producing manner, that is, in the form of sounds or music.

When the display unit 220 obtains a signal corresponding to video data from the information processing device 300, the display unit 220 suitably conducts suitable processing and outputs in the form of image and video image. Examples of the display unit 220 includes a liquid crystal display panel, organic EL (Electro Luminescence) panel, a PDP (Plasma Display Panel), a CRT (Cathode-Ray Tube), an FED (Field Emission Display), and an electrophoretic display panel.

The information processing device 300 is a so-called DJ playback device, which processes contents recorded on a recording medium (not shown) so that the contents can be outputted from the output unit 200. The processing of the contents is equivalent to, for example, a manipulation similar to that conducted by a performer called a disc jockey (DJ) when the disc jockey plays music information on a phonograph record disc with a phonograph record player.

Examples of the recording medium include not only detachable media such as optical discs such as a CD-ROM (Compact Disc-Read Only Memory), a DVD-ROM (Digital Versatile Disc-Read Only Memory), a DVD-R (Digital Versatile Disc-Recordable), and a DVD-RW (Digital Versatile Disc-ReWritable), magnetic discs such as an MO (magneto-optical) disc and an HD (Hard Disk), and cards such as a memory card and an IC (Integrated Circuit) card, but also semiconductor memory and the like.

As exemplarily shown in FIG. 2, the information processing device 300 has a body case 301 formed of ABS (Acrylonitrile-Butadiene-Styrene) resin in a substantially rectangular shape. The body case 301 houses an information processing unit 400 as a calculating unit which forms the information processing device that conducts processing for reading out the contents recorded on the recording medium and outputting (i.e. reproducing) the contents from the output unit 200. An insertion slot 302 that is laterally opened is provided on a side, or more specifically, on a front side (the lower side in FIG. 2) of the body case 301. The recording medium can be inserted through the insertion slot 302 and conveyed in and out of the body case 301. Incidentally, the insertion slot 302 is not limited to a single slot, but may include, in the case various types of recording media can be used, a plurality of slots corresponding to the various types of recording media.

A first display device 310 disposed in a manner partially exposed to the exterior of the body case 301, a drive 330, a switch section 340 that forms the manipulation unit, a communication unit 350, a storing unit 360, a switching device 500, an information processing unit 400, and the like are provided in the body case 301 of the information processing device 300.

The first display device 310 is disposed facing an upper side (a side shown by FIG. 2) of the body case 301 and connected to the information processing unit 400. The first display device 310 displays characteristics of the contents and processing status via control signals outputted from the information processing unit 400.

Specifically, for example, in the case where a plurality of video data recorded on the recording medium are processed, the displayed items include: a number that tells the quantity of the video data and a track number that tells a sequential order of the video data undergoing reproduction processing; a total reproduction time for all the recorded video data, a reproduction time for each of the video data, and a reproduction time for the video data being reproduced; reproduction speed of the video data being reproduced; a sound volume of audio data at the reproduction position of the video data and in the vicinity of the reproduction position and a sound volume in a bass range no higher than a predetermined frequency; and a ratio of the speed of video data being reproduced with respect to a normal reproduction speed.

A variety of display devices may be employed for the first display device 310. For example, a liquid crystal display panel, an organic EL panel, a PDP, a CRT, a FED, or an electrophoretic display panel may be employed.

The drive 330, to which the recording medium is detachably attached, is connected to the information processing unit 400 to conduct readout processing in which the contents recorded on the recording medium is read out and also record processing in which the contents are recorded on the recording medium via control signals outputted from the information processing unit 400.

The drive 330 is capable of accepting the above-mentioned various types of recording media. In other words, for example, in the case the recording medium is an optical disc, an optical pickup may be provided. In the case the recording medium is a magnetic disc, a magnetic head may be provided. In the case a memory card is employed, a connector may be included, and a driver for processing may be provided.

Incidentally, the arrangement of the drive 330 is not limited to one arrangement. A plurality of arrangements which allow accepting the various types of recording media may be provided.

The switch section 340 is connected to the information processing unit 400, and includes a plurality of switch sections 340 is disposed facing the upper side of the body case 301 to allow a user to conduct an input manipulation. The switch section 340 outputs predetermined manipulation signals corresponding to the input operation to the information processing unit 400, and determines a status for processing the contents in the information processing unit 400.

Various reproducing states and the like are input and set in the switch section 340. For example, the recording medium attached at a clamp position in the drive 330 may be conveyed out of the body case 301 via the insertion slot 302. The reproduction speed may be changed. A predetermined position of the video data may be specified to be marked. Reproduction may be repeated.

The communication unit 350 is connected to the information processing unit 400. The information processing unit 400 controls the communication unit 350 to connect via network, for example, to a server device that stores contents in a distributable manner or to a terminal device such as a personal computer, obtains the stored contents, and outputs the contents to the information processing unit 400.

Examples of the network include: the Internet, intranet, and LAN (Local Area Network) based on multi-purpose protocol such as TCP (Transmission Control Protocol)/IP (Internet Protocol); a network such as a communication line network in which a plurality of base stations capable of sending and receiving contents via wireless media form network and a broadcasting network; and wireless media that itself form media for directly sending and receiving contents. Media such as radio waves, light, sound waves, and electromagnetic waves may be applied for the wireless media.

Incidentally, contents obtained by the communication unit 350 and outputted to the information processing unit 400 are suitably stored in the storing unit 360 so that the contents can be suitably read out.

Examples of arrangements of the storing unit 360 include a drive or a driver that conduct storing on various recording media including a magnetic disc such as an HD (Hard Disk), an optical disc such as a DVD (Digital Versatile Disc), a memory card and the like. Semiconductor memory and the like may also be employed.

The storing unit 360 also stores various programs run on an OS (Operating System) that controls operation of the entire information processing device 300.

Furthermore, the storing unit 360 can temporarily store signals to be processed when the information processing unit 400 performs calculation. In short, the storing unit 360 also functions as a memory.

The switching device 500 is, for example, shaped to assume a turntable of a phonograph record player for reproducing a phonograph record disc. The switching device 500 is disposed substantially at the center of a flat upper side of the body case 301 so that the user can operate inputting manipulations, and outputs to the information processing unit 400 manipulation signals corresponding to the input manipulations and variably sets the processing state of the contents data.

Specifically, in the case the video data is processed for reproduction, reproducing states such as the reproducing speed, the reproducing direction, and stop and restart of reproduction are varied, thus the processing state of the contents being variably set. Incidentally, not only the video data but also audio data can be variably set.

Next, the switching device 500 includes a rotary body section 600 as a manipulation element that forms the manipulating unit. The rotary body section 600 has a jog table section 610 and a job ring section 650.

The jog table section 610 is substantially disc-shaped, in which a cylindrical portion (not shown) is formed in a substantially cylindrical shape from a periphery of a substantially disc-shaped table plate 611. The jog ring section 650 shaped as a ring, and the jog table section 610 is fittingly inserted in the inner circumference side of the ring in a manner that the jog table section 610 is movable in an axial direction and is engaged with the jog ring section 650 to be prohibited from moving in a circumferential direction.

In the switching device 500 is provided with: a press detecting unit 820 such as a touch sensor disposed at a predetermined position of the table plate of the jog table section 610; and a rotary movement detecting unit 810 that detects rotary movement caused by manipulation of integral rotation of the jog table section 610 and the jog ring section 650. A display window 612 is provided substantially at the center of the table plate 611. A second display device 320 housed in the body case 301 faces the display window 612. The switching device 500 outputs a manipulation signal corresponding to a contact, a pressing manipulation, and a rotating manipulation by a user detected by the press detecting unit 820 and the rotary movement detecting unit 810.

Incidentally, the press detecting unit 820 is not limited to the press sensor. Various arrangements may be employed. For example, a switch arrangement which is mechanically turned on and off on account of a downward movement of the jog table section 610 caused by the pressing manipulation may be employed. An electrostatic sensor may also be employed. The rotary movement detecting unit 810 is not limited to an arrangement in which rotation is directly detected by an optical sensor or a magnetic sensor, but various arrangements may be employed. For example, a mechanical arrangement in which rotations of a gear or a roller that engages with the rotation are detected may be employed.

The information processing unit 400, which is provided with, for example, a CPU (Central Processing Unit), includes various input and output ports (not shown) such as: a display control port to which the first display device 310 and the second display device 320 are connected; a drive control port to which the drive 330 is connected; an input port to which the switch section 340, the press detecting unit 820, and the rotary movement detecting unit 810 are connected; a communication port to which the communication unit 350 is connected; and a storage port to which the storing unit 360 is connected.

The information processing unit 400 includes a manipulation signal recognizing unit 410, an information retrieving unit 420, a characteristics recognizing unit 430, a display controlling unit 440, a processing unit 450 and the like in the form of various programs.

The manipulation signal recognizing unit 410 recognizes various manipulation signals outputted from the switch section 340 and detection signals outputted from the rotary movement detecting unit 810 and the press detecting unit 820, recognizes request of changing processing conditions or processing status of contents inputted by manipulation of a user, and sets a processing state of contents.

The signals relating to the settings of the processing state are suitably outputted to the data format discriminating unit and output format discriminating unit in the form of the information retrieving unit 420, the characteristics recognizing unit 430, the display controlling unit 440, the processing unit 450 and the like.

When the information retrieving unit 420 recognizes the signals relating to the settings of the predetermined processing status outputted from the manipulation signal recognizing unit 410, that is, instruction signals instructing to read out predetermined contents to be processed, the information retrieving unit 420 controls the drive 330 and the storing unit 360 to operate to read out the desired contents recorded on the recording medium, and obtains the contents.

The information retrieving unit 420 retrieves recording status of the contents recorded on the recording medium. For example, the information retrieving unit 420 retrieves: the reproduction time; a number of the contents recorded; and a broadcast format in terms of the data format, specifically, which of the NTSC format, the PAL format, and the SECAM format is employed. An example of the retrieval of the recorded information is as follows. If it is recognized from signals outputted from the drive 330 that the recording medium is attached to the drive 330, or if it is recognized via the input manipulation or the like with the switch section 340 or the like that an object to be processed is the contents stored in the storing unit 360, operations of the drive 330 and the storing unit 360 are controlled so that the playlist, TOC (Table Of Contents) information, program information or the like is read out and obtained.

Further, the information retrieving unit 420 discriminates broadcast format, which is data format of the display unit 220 of the output unit 200 to which the information retrieving unit 420 is connected. Specifically, the information retrieving unit 420 discriminates which of the NTSC format, the PAL format, and the SECAM format the broadcast format is. In the recognition of the data format, for example, a predetermined control signal is outputted to the display unit 220, and discrimination is conducted based on the signals outputted from the display unit 220. The information retrieving unit 420 suitably makes the storing unit 360 to store information relating to the data format which is the discriminated display format of the display unit 220. The stored information is stored till the connection of the display unit 220 is abandoned or power supply of the information processing device 300 is turned off.

Further, the information retrieving unit 420 controls the operation of the communication unit 350, for example, based on input manipulation on the switch section 340 or the like and request signals outputted from the terminal device or the like connected to the information processing device 300, to receive contents of which retrieval is requested from the server device or the terminal device and obtains the contents.

The characteristics recognizing unit 430 recognizes characteristics of the contents retrieved by the information retrieving unit 420 as the object to be processed and retrieves the same as characteristics information. The characteristics of the contents are, for example, a volume, a pitch, a tempo and the like if the contents are the music data, and brightness, contrast, hue and the like if the contents are the video data.

The characteristics of the contents are not limited to the information relating to the characteristics recorded on the recording medium associated with the contents, but may also be recognized, for example, based on frequency or the like when the processing unit 450 processes the contents for reproduction and obtained as characteristics information. For example, regarding volume in a bass range no higher than a predetermined frequency, components no higher than the predetermined frequency is obtained by a low pass filter, and a magnitude of the sound volume greater than the predetermined magnitude, particularly the peak value, is recognized as characteristics.

In addition, the characteristics recognizing unit 430 recognizes an elapsed time, which is time information from a reproduction starting position at the position where the peak value of the bass range forming the characteristics, based on minutes and seconds that are time information included in the recorded information or based on the number of frames. Specifically, in the case a plurality of peaks that are volumes no smaller than the predetermined value exist, the peaks are sequentially applied with identification numbers or the like starting from the reproduction start, while the elapsed time is sequentially recognized. The peaks and the time are associated to generate peak information in the characteristics information. These generated peak information are sequentially stored in the storing unit 360.

The characteristics recognizing unit 430 suitably outputs characteristics information related to the characteristics of the recognized contents also to the display controlling unit 440.

The display controlling unit 440 controls the first display device 310 and the second display device 320 to suitably display the settings and the processing status of the contents corresponding to the signals concerning the settings of the processing status outputted from the manipulation signal recognizing unit 410 and various information relating to the characteristics of contents recognized by the characteristics recognizing unit 430.

Incidentally, the displaying may be assigned to the display unit 220 of the output unit 200.

The processing unit 450, which exemplarily includes a CPU, conducts reproduction processing on the contents, which are to be processed and have been retrieved by the information retrieving unit 420, to put the contents into a state capable of being suitably outputted from the output unit 200 like the above-mentioned settings in correspondence with the signals relating to the settings of the processing status outputted from the manipulation signal recognizing unit 410

The processed contents are suitably outputted to the output unit 200 and reproduced in correspondence with the settings. In other words, the processing may be conducted to allow normal reproduction, or the processing may be conducted to set or change reproduction position of the contents and the reproduction speed, the tempo, the pitch or the like in correspondence with the settings set by a rotating, pressing or contacting manipulation of the rotary body section 600 or input manipulation in the switch section 340.

As shown in FIG. 3, specifically, the processing unit 450 includes: a demultiplexer 451; a video decoder 452; an audio decoder 453; a video output controller 454; a video field converter 455; an audio output controller 456; and an audio pitch controller 457.

The demultiplexer 451 suitably retrieves contents data outputted from the drive 330 and separates the video data and the audio data. For example, the demultiplexer 451 separates video data in the MPEG (Moving Picture Expert Group) format and audio data in the AC-3 format. The video data is suitably outputted to the video decoder 452, and the audio data is suitably outputted to the audio decoder 453.

The video decoder 452 suitably retrieves video data from the demultiplexer 451, decodes the video data, and suitably converts the video data to digital video signals. In the decoding process, the video decoder 452 conducts an accelerated decoding processing at a speed of 6/5 times as fast or faster if the video data is the PAL format or the SECAM format and the display format of the display unit 220 of the output unit 200 is the NTSC format, and the video decoder 452 conducts an accelerated decoding process at a speed of 5/6 times as fast or faster if the video data is the NTSC format and the display unit 220 is PAL format or the SECAM format. The video decoder 452 adds time information, which has been retrieved while decoding, to digital video signals decoded and converted and suitably outputs the yield to the video output controller 454.

The video output controller 454 manages the digital video signals retrieved from the video decoder 452 while associating the digital video signals with the time information that are simultaneously retrieved. When the video output timing has come, the video output controller 454 selects, based on time information of output audio data at the time point video data having the most appropriate time information, and suitably outputs the yield to the video field converter 455.

The video field converter 455 converts the video signal from the video output controller 454 to a number of scanning lines corresponding to the data format of the display unit 220. Specifically, the video field converter 455 conducts line skipping to reduce 576 lines in the vertical direction to 480 lines if the video data is the PAL format or the SECAM format and the display unit 220 is the NTSC format, and conducts interpolation processing to increase the 480 lines in the vertical direction to 576 lines if the video data is the NTSC format and the display unit 220 is the PAL format or the SECAM format. Subsequently, the video field converter 455 sequentially outputs the video signals having undergone converting process of the scanning lines to the display unit 220.

The audio decoder 453 suitably retrieves audio data from the demultiplexer 451 and suitably converts to digital audio signals. In the decoding process, similarly to the video decoder 452, the accelerated decoding processing is conducted at a speed corresponding to the data format to be converted. Specifically, the audio decoder 453 conducts an accelerated decoding processing at a speed of 6/5 times as fast or faster if the video data is the PAL format or the SECAM format and the display format of the display unit 220 of the output unit 200 is the NTSC format, and the audio decoder 453 conducts an accelerated decoding processing at a speed of 5/6 times as fast or faster if the video data is the NTSC format and the display unit 220 is the PAL format or the SECAM format. The audio decoder 453 adds time information, retrieved while decoding, to digital audio signals decoded and converted and suitably outputs the yield to the audio output controller 456.

The audio output controller 456 manages the digital audio signals from the audio decoder 453 while associating the digital audio signals with the time information simultaneously retrieved. Subsequently, the audio output controller 456 outputs the audio signals, having been associated with the time information, at a predetermined speed, for example, at a speed of 6/5 times as fast in the above-mentioned case of the PAL format (the SECAM format) to the NTSC format and at a speed of 5/6 times as fast in the case of the NTSC format to the PAL format (the SECAM format) to the audio pitch controller 457.

The audio pitch controller 457, including, for example, a DSP (Digital Signal Processor), suitably retrieves audio signals from the audio output controller 456 and conducts processing to change highs and lows of sounds of the audio signals. For example, the pitch is lowered in the case of audio signals outputted at a speed 6/5 times as fast, and the pitch is elevated in the case of the audio signals outputted at a speed 5/6 times as fast, so that the audio characteristics is adjusted to equalize the outputted pitch with a pitch outputted without scaling up or down. Subsequently, the audio pitch controller 457 sequentially outputs the video signals having undergone adjustment of the audio characteristics to the sound producing unit 210 of the output unit 200.

Operation of Reproducing System

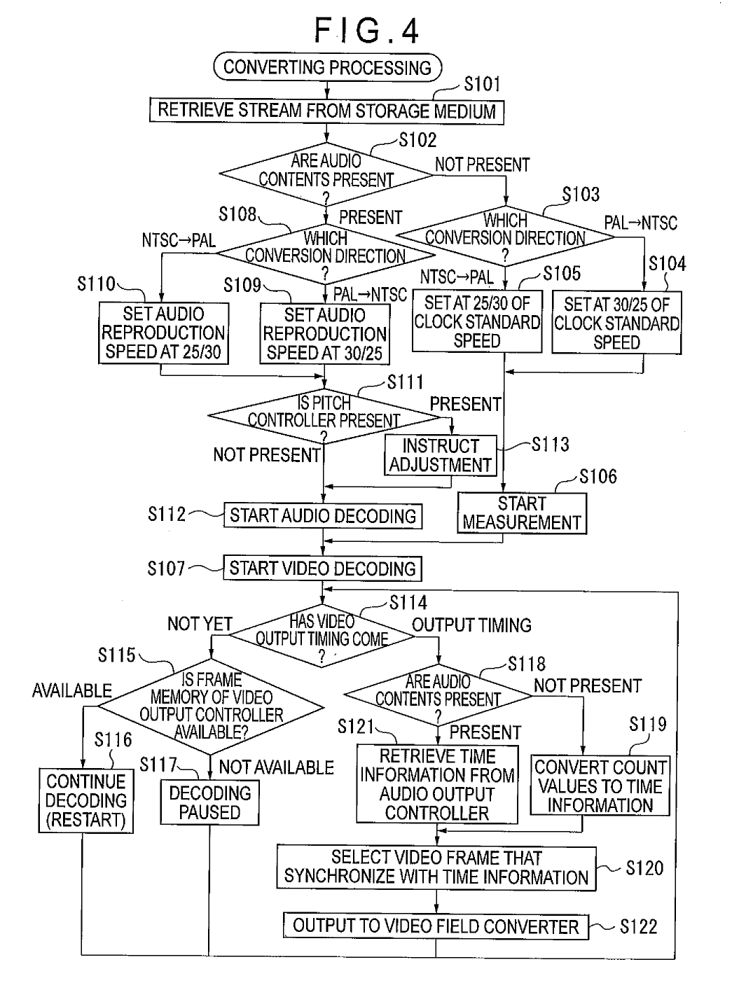

Next, the operation of the above-described reproducing system will be described with reference to FIG. 4.

FIG. 4 is a flowchart showing an operation of a reproducing process of contents in the information processing device.

Initially, power supply of the reproducing system 100 is turned on, and the information processing unit 400 of the information processing device 300 recognizes instruments connected to the information processing unit 400. In the embodiment, connection of the output unit 200 is recognized in addition to the internal arrangement including the first display device 310, the second display device 320, the drive 330, the switch section 340, the communication unit 350, the storing unit 360, and the switching device 500.

By the information retrieving unit 420, the information processing unit 400 outputs the predetermined control signal, for example, to the display unit 220 and discriminates the broadcast format which is the data format of the display unit 220 based on the signals outputted from the display unit 220. Specifically, it is discriminated which of the NTSC format, the PAL format, and the SECAM format the format is. The information retrieving unit 420 stores the data format of the display unit 220 having been discriminated in the storing unit 360.

The information processing unit 400 controls the drive 330 to judge whether a recording medium is attached to the drive 330. If it is judged that a recording medium is not attached, the information processing unit 400 becomes a standby state.

When a recording medium such as an optical disc is inserted in the insertion slot 20 302, the information processing unit 400 controls the drive 330 to operate. In other words, the recording medium is attached to a predetermined position of the drive 330 in the body case 301, for example, by an automatic loading mechanism.

When the information processing unit 400 recognizes that the recording medium is attached to the drive 330, the information retrieving unit 420 controls the drive 330 to operate to read out the recorded information recorded on the recording medium. Furthermore, the information processing unit 400 controls the first display device 310 by the display controlling unit 440 to display the recorded information.

Subsequently, by the manipulation signal recognizing unit 410, the information processing unit 400 recognizes the manipulation signals outputted by the switch section 340 via input manipulation by the user, and the information processing unit 400 sets a processing state as inputted.

The information processing unit 400 becomes the standby state waiting for selection of contents data to be processed. In other words, the information processing unit 400 judges which contents have been selected. When it is recognized that the contents to be processed have been selected via input manipulation with the switch section 340 and the switching device 500, the information retrieving unit 420 controls the drive 330 and the communication unit 350 or the storing unit 360 to read out the selected music data or receive and retrieve contents (Step S101).

The information retrieving unit 420 judges whether the retrieved contents in Step S101 contain music data (Step S102). The presence of music data is judged, for example, by the recorded information contained in the contents, the recorded information associated with the contents, and separation processing with the demultiplexer 451 of the processing unit 450. Furthermore, the information retrieving unit 420 recognizes, based on the recorded information and the like, the broadcast format which is the data format of the selected contents to be reproduced.

If the data structure is judged in Step S102 not to contain music data, in other words, if the data structure is judged in Step S102 to be reproduced by displaying video data, text data, or the like, in order to judge whether conversion of the data format is necessary, the processing unit 450 compares the data format of the contents and the data format of the display unit 220 recognized and stored in advance. In the judgment of the data format, if the data format is judged to be equal, the retrieved contents data is suitably processed and outputted to the output unit 200 to be reproduced.

If it is judged that the conversion of the data format is necessary because the data formats are different, what particularly is to be converted is judged (Step S103). Specifically, judgment is made between a first data-format-conversion direction from the PAL format (the SECAM format) to the NTSC format and a second data-format-conversion direction from the NTSC format to the PAL format (the SECAM format).

If the judgment is made in favor of the first conversion direction from the PAL format (the SECAM format) to the NTSC format, the processing unit 450 sets the decoding process to be an acceleration decoding process at a speed 6/5 times as fast. In other words, with respect to the clock standard speed that is a decoding processing speed at which the reproduction is conducted again in the PAL format (the SECAM format), the setting is provided to allow an accelerated decoding process at a speed 30/25 times as fast for reproduction at a frame number of the NTSC format which has replaced the PAL format (the SECAM format) (Step S104).

If the judgment is made in favor of the second conversion direction from the NTSC format to the PAL format (the SECAM format), the processing unit 450 sets the decoding process to be an accelerated decoding process at a speed 5/6 times as fast. In other words, with respect to the clock standard speed that is a decoding processing speed at which the reproduction is conducted again in the NTSC format, the setting is provided to allow an accelerated decoding process at a speed 25/30 times as fast for reproduction at a frame number of the PAL format (the SECAM format) which has replaced the NTSC format (Step S1105).

After the processes in Step S104 and Step S105, the processing unit 450 starts time measurement based on the clock, or for example, starts time measurement by measuring the clock signals (Step S106), and the frames of the video data are sequentially decoded (Step S107).

If the data structure is judged in Step S1102 to contain audio data, in order to judge whether conversion of the data format is necessary, the processing unit 450 compares the data format of the contents and the data format of the display unit 220 having been recognized and stored in advance. In the judgment of the data format, if the data format is judged to be equal, the retrieved contents data is suitably processed and outputted to the output unit 200 to be reproduced.

If it is judged that the conversion of the data format is necessary because the data formats are different, what particularly is to be done in the conversion process is judged (Step S108). Specifically, a judgment is made between a first data-format-conversion direction from the PAL format (the SECAM format) to the NTSC format and a second data-format-conversion direction from the NTSC format to the PAL format (the SECAM format).

If the judgment is made in favor of the first conversion direction from the PAL format (SECAM format) to the NTSC format, the processing unit 450 sets the reproduction speed of the audio data to be at a speed 6/5 times as fast. In other words, 25 frames/second that is the processing speed of the video data at which the reproduction is conducted again in the PAL format (the SECAM format) is changed to 30 frames/second that is the processing speed in the NTSC format, and in correspondence with this, the reproduction speed of 30/25 to provide synchronization with sounds (Step S109).

If the judgment is made in favor of the second conversion direction from the NTSC format to the PAL format (the SECAM format), the processing unit 450 sets the reproduction speed of the audio data to be at a speed 5/6 times as fast. In other words, 25 frames/second that is the processing speed of the video data at which the reproduction is conducted again in the NTSC format is changed to 30 frames/second that is the processing speed in the PAL format (the SECAM format), and in correspondence with this, the reproduction speed of 25/30 is set to provide synchronization with sounds (Step S110).

After processing of Step 5109 or Step S110, the processing unit 450 judges whether the pitch controller arrangement, which is the audio pitch controller 457 arrangement is present (Step S111).

In Step S111, if the audio pitch controller 457 is judged not to be present, the processing unit 450 conducts the decoding processing of the audio data sequentially at an unchanged speed (Step S112), and Step S107 follows, in which the frames of the video data are sequentially decoded.

In Step S111, if the audio pitch controller 457 is judged to be present, the processing unit 450 controls the audio pitch controller 457 at the reproduction speed set at Step S109 or Step S110, or in other words, adjusts the speed of the decoding processing (Step S113), and conducts decoding processing of the audio data at the reproduction speed adjusted in Step S112. Step S107 follows, in which the processing unit 450 sequentially decodes the frames of the video data.

After the decoding process of the video data in Step S107, the processing unit 450 judges whether the output timing of the video data has come (Step S114). In other words, a judgment is made whether a timing of reproducing the frames, having been sequentially decoded and accumulated in buffers (not shown), by the output unit 200 has come based on time information managed by the video output controller 454 and the audio output controller 456. Incidentally, if no audio data is present, time information is not managed by the audio output controller 456, so that the judgment is made based on time information in the video output controller 454.

If the processing unit 450 judges the output timing of the video data has not come, the processing unit 450 judges available memory in the frame memory which is the buffer in the video output controller 454 for the video data.

In Step S115, if a judgment is made that memory is available in the frame memory of the video output controller 454, the decoding process is continued in an unchanged manner (Step S116), and the operation returns to Step S114.

In Step S115, if a judgment is made that memory is not sufficiently available in the frame memory of the video output controller 454, the decoding process is paused (Step S117), and the operation returns to Step S114.

In Step S114, if the processing unit 450 judges that the output timing of the video data has come, the processing unit 450 judges presence of the audio data (Step S118).

In Step S118, if it is judged that the audio data is not present, the count values counted in Step S106 is converted to time information (Step S119), and the frame of the video data that synchronizes with the time information is selected (Step S120).

In Step S118, if it is judged that the audio data is present, time information managed by the audio output controller 456 is retrieved (Step S121), and Step S120 follows, in which the frame of the video data that synchronizes with the time information is selected.

After the selecting process of the frame in Step S120, the processing unit 450 makes the video output controller 454 to output the frames of the video data to the video field converter 455 (Step S122), and the operation returns to Step S114.

In other words, in the video field converter 455, the frame images are converted to a line number of scanning lines that corresponds to the data format of the display unit 220. Then, the frame images are outputted to the output unit 200 and reproduced.

Effects of Reproducing System

As described above, in the embodiment, the information retrieving unit 420 discriminates the data format of the contents that include the video contents to be retrieved. In addition, the data format during the reproduction by the display unit 220 of the output unit 200 is discriminated. If the processing unit 450 recognizes that the data format of the contents and the data format of the display unit 220 are different, the contents retrieved by the information retrieving unit 420 are converted to a reproduction speed corresponding to the data format by the display unit 220 and outputted to the output unit 200.

Accordingly, the frames need not be skipped, and newly produced frames need not be interpolated between the frames. Thus, the flickering and discontinuity of the video images reproduced on the display unit 220 are prevented. Therefore, smooth video images can be obtained, and at the same time, cumbersomeness of operations and complication of arrangements are prevented to achieve improvements in productivity and cost reduction. In short, smooth video images can easily be obtained with a simple arrangement in which frames of the video contents are outputted in a manner sequentially suitably changing the reproduction speed.

Specifically, in the case of a visual DJ playback that does not accompany sounds or the like, smooth video reproduction can be obtained, thereby allowing a favorable visual DJ playback.

In addition, even in the case accompanied by sounds, synchronization with the video contents of which the reproduction speed is changed can be easily obtained by easy processing in which frequency characteristics are changed or pitches are changed, thereby allowing favorable reproduction of the contents.

The processing unit 450 converts the reproduction speed of the contents. Specifically, the reproduction speed undergoes speed-multiplying processing relative to the case where the data format of the contents is the same as the data format in the display unit 220 that performs reproduction.

Accordingly, the display unit 220 only needs to change the speed during the reproduction processing where the speed is the speed of reproduction in the display unit 220. Thus, the processing is easy, and the contents with a different data format can be reproduced easily in smooth video images.

Furthermore, the processing unit 450 converts the reproduction speed via speed-multiplying processing. Specifically, decoding processing that is conducted at a decoding speed is conducted in an accelerated decoding processing manner.

Accordingly, the reproduction speed is changed by simply conducting the decoding processing suitably in an accelerated decoding manner, so that the contents having different data formats can be reproduced easily in smooth video images with a simple arrangement.

In addition, the data format is recognized according to the broadcast format.

Accordingly, the judgment whether the data format can be reproduced in the display unit 220 is easy. At the same time, it is necessary to recognize the broadcast format of the display unit 220 only upon connection of the display unit 220 or startup of the information processing device 300, thereby facilitating the processing and easily allowing swift processing.

The data format may be recognized with number information of the display lines that are scanning lines. With this arrangement, the difference in the data formats can be easily recognized, thereby easily improving the processing efficiency. For example, the data formats for the processing of the contents based on the PAL format and the NTSC format, which are different in the numbers of the scanning lines, can be discriminated easily and swiftly.

The data format may be recognized with color-related signals such as color signals. With this arrangement, the difference in the data formats can be easily recognized, thereby easily improving the processing efficiency. For example, the data formats for the processing of the contents based on the PAL format and the SECAM format, which are the same in the numbers of the scanning lines but are different in the data formats, can be discriminated easily and swiftly.

Specifically, regarding the conversion from the NTSC format to the PAL format, the video contents of the contents data undergo accelerated decoding processing at a speed of 5/6 times as fast or faster, and regarding the conversion from the PAL format to the NTSC format, the video contents undergo accelerated decoding processing at a speed of 6/5 times as fast or faster.

Accordingly, the accelerated decoding processing at a predetermined reproduction speed easily allows smooth video reproduction of contents having different data formats.

Conversion to the reproduction speed of the frames reproduced in the display unit 220 can be conducted via simple speed-multiplying processing, thereby easily allowing smooth reproduction by a simple arrangement.

If the audio contents are contained, the frequency characteristics of the audio contents are changed.

Accordingly, by reproducing sounds, which are to be synchronized with the smoothly reproduced video images, with the same characteristics as those in the case of the constant-speed reproduction, a reproduction state of the contents without an odd impression can be obtained. A favorable reproduction state is thus provided.

Specifically, because the frequency characteristics are changed in a proportion (ratio) corresponding to the speed-multiplying processing of the reproduction speed, a favorable reproduction state is easily provided with a simple arrangement.

The processes are set in an executable manner in the form of programs in a CPU, an AV processor, or a DSP. With this arrangement, or in other words, by embedding the programs, and further, by using a recording medium on which the programs are recorded, the above processes are easily obtained and use of the processes is easily widened.

### Modifications of Embodiment

Incidentally, the invention is not limited to the embodiment set forth above, but includes modification set forth below as long as an object of the invention is achieved.

Specifically, the above exemplary arrangement includes a rotary body section 600 for DJ playback. Nevertheless, for example, the invention may be implemented in devices such as remote controllers widely used in the audio devices for home-installation.

The conversion of the audio contents is not limited to changing the frequency characteristics. For example, the audio data may be skipped by microseconds or modulated to a drawling state by microseconds with a predetermined time interval. A suitable method may be employed to correspond to the reproduction speed into which the video contents are converted.

The audio contents may simply be synchronized and reproduced. Specifically, the DJ playback does not always require audio contents. In a DJ playback, audio contents may be obtained via other audio contents, and only the video contents may be reproduced. In such a case, because it is required that the audio contents are not reproduced, a reproducing system to which the sound-producing unit 210 is not connected may be employed, or sound pressure of the audio contents may be set to be “0” so that the audio contents are not outputted.

The information processing device 300 that can conduct both the NTSC format to the PAL format and the PAL format to the NTSC format is shown as an example. Nevertheless, if the data format to be reproduced is predetermined, for example, in the case of television in which the display unit 220 is integrally arranged, the processing may be conducted with only one of the formats.

The scope of the invention is not limited to the NTSC format to the PAL format or the PAL format to the NTSC format. The NTSC format to the SECAM format, the SECAM format to the NTSC format, the SECAM format to the PAL format, the PAL format to the SECAM format, or the like may be employed. Furthermore, the broadcast format is not a limitation, and other data formats may be employed.

The conversion of the reproduction speed is not limited to a process of simply changing the decoding speed, but any other suitable method may be employed.

Moreover, the data format of the display unit 220 is not limited to being automatically discriminated by recognizing and discriminating the signals from the display unit 220. A manual discrimination in which signals outputted from a manipulation unit in relation with the data format of the display unit 220 are recognized and discriminated by a user via input manipulation on the manipulation unit having a manipulation button or the like.

In the case the data format of the video data outputted from a tuner is converted in correspondence with the display unit 220, the video data retrieved in the information processing device 300 is broadcasting data received by the tuner that is stored and reproduced.

From the above, the information processing device according to an aspect of the invention may be arranged to start reproduction after the storing processing is conducted via the tuner itself or via a device that stores the broadcasting data received by the tuner.

A program that can be read out by a computer as a calculating unit may be employed. The computer may be operated to process the contents recorded on a recording medium attached to the computer so that the contents become capable of being outputted, for example, of being reproduced as set forth above. Furthermore, a television device integrally including the display unit 220 and the sound-producing unit 210 may be employed. A device integrally including an optical disc drive or an HDD may be employed. All of these may also be integrally included in the device arrangement. The calculating unit in the invention includes: a personal computer; an arrangement in which a plurality of computers are set together in a network; an element such as a microcomputer; and a circuit board on which a plurality of electronic components are installed.

Other than the above, a specific structure and procedure for implementing the invention may suitably be changed into another structure or the like as log as an object of the invention is achieved.

### Effects of Embodiment

As described above, the information retrieving unit 420 discriminates the data format of the contents that include the video contents to be retrieved. In addition, the data format during the reproduction in the display unit 220 of the output unit 200 is discriminated. If the processing unit 450 recognizes that the data format of the contents and the data format of the display unit 220 are different, the contents retrieved by the information retrieving unit 420 are converted to a reproduction speed corresponding to the data format in the display unit 220 and outputted to the output unit 200.

Accordingly, the frames need not be skipped, and newly produced frames need not be interpolated between the frames. Thus, the flickering and discontinuity of the video images reproduced on the display unit 220 are prevented. Therefore, smooth video images can be obtained, and at the same time, cumbersomeness of operations and complication of arrangements are prevented to achieve improvements in productivity and cost reductions. In short, smooth video images can easily be obtained with a simple arrangement in which frames of the video contents are outputted in a manner suitably sequentially changing the reproduction speed.

### INDUSTRIAL APPLICABILITY

The present invention can be applied to an information processing device for processing information in different formats, a method of processing information in different formats, a program of the same, a recording medium on which the program is recorded, a reproducing device for a disc jockey, and a reproducing device.

1. An information processing device that can be connected to an output unit which comprises a display device and processes contents data containing video contents to enable reproduction, comprising:
a contents data retrieving unit that retrieves the contents data;
a data format discriminating unit that discriminates a data format of the contents data;
an output format discriminating unit that discriminates a data format of the display device; and
a processing unit that reproduces the contents data and outputs the contents data to the output unit, wherein
the output format discriminating unit retrieves signals concerning the data format of the display device to discriminate the data format of the display device,
when the processing unit recognizes that the data format of the contents data is different from the data format in the display device, the processing unit converts a production speed of the contents data to correspond to the data format in the display device by changing a decoding speed of the contents data, and
if the contents data comprises audio contents, frequency characteristics of the audio contents is modified by a ratio that corresponds to a ratio of conversion of the reproduction speed,

2. (canceled)

3. The information processing device according to claim 1, wherein
the conversion of the reproduction speed is effected by converting a first reproduction speed at which the video contents is reproduced without being format-converted into a second reproduction speed that corresponds to the different data format in the reproducing device through a speed-multiplying process.

4. (canceled)

5. The information processing device according to claim 1, wherein
the data format discriminating unit and the output format discriminating unit discriminate the data format according to a broadcast format.

6. The information processing device according to claim 5, wherein
the processing unit converts the reproduction speed via decoding the video contents of the contents data at 5/6 times or faster if the broadcast format of the contents data is the NTSC format and the broadcast format in the display device is the PAL format and via decoding the video data of the contents data at 6/5 times or faster if the broadcast format of the contents data is the PAL format and the broadcast format of the display device is the NTSC format.

7. (canceled)

8. (canceled)

9. A DJ playback device that processes contents data that contains video contents to enable reproduction by an output unit that includes a display unit, comprising:
a manipulation unit that comprises a manipulation element provided rotatable by a rotation manipulation and outputs a manipulation signal that corresponds to manipulation of the manipulation element;
a processing unit that reproduces the video contents and outputs the video contents to the output unit;
a contents data retrieving unit that retrieves the contents data;
a data format discriminating unit that discriminates a data format of the contents data; and
an output format discriminating unit that discriminates a data format valid during reproduction in the display device of the output unit, wherein
the output format discriminating unit retrieves signals concerning the data format of the display device to discriminate the data format of the display device,
when the data format of the contents data is recognized to be a data format different from the data format in the display device, the processing unit converts, by changing a decoding speed of the contents data, a reproduction speed of the contents data to correspond to the data format in the display device before outputting to the output unit, and
if the contents data comprises audio contents, frequency characteristics of the audio contents is modified by a ratio that corresponds to a ratio of conversion of the reproduction speed.

10. An information processing method that processes, via a calculating unit, contents data that contains video contents to enable reproduction by an output unit that includes a display unit, wherein
the calculating unit conducts
a contents data retrieving step that retrieves the contents data,
a data format discriminating step that discriminates a data format of the contents data,
an output format discriminating step that retrieves signals concerning the data format of the display device and discriminates a data format valid during reproduction in the display device, and
a processing step that, when the data format of the contents data is recognized to be different from the data format in the display device, converts by changing a decoding speed of the contents data, a reproduction speed of the contents data to correspond to the data format in the display device, and if the contents data comprises audio contents, frequency characteristics of the audio contents is modified by a ratio that corresponds to a ratio of conversion of the reproduction speed, before outputting to the output unit.

11. An information processing program, wherein
the information processing program operates a calculating unit as an information processing device or a DJ playback device, wherein
the information processing device can be connected to an output unit which comprises a display device and processes contents data containing video contents to enable reproduction and comprises comprising: a contents data retrieving unit that retrieves the contents data; a data format discriminating unit that discriminates a data format of the contents data; an output format discriminating unit that discriminates a data format of the display device; and a processing unit that reproduces the contents data and outputs the contents data to the output unit,
the DJ playback device processes contents data that contains video contents to enable reproduction by an output unit that includes a display unit and comprises a manipulation unit that comprises a manipulation element provided rotatable by a rotation manipulation and outputs a manipulation signal that corresponds to manipulation of the manipulation element; a processing unit that reproduces the video contents and outputs the video contents to the output unit; a contents data retrieving unit that retrieves the contents data; a data format discriminating unit that discriminates a data format of the contents data; and an output format discriminating unit that discriminates a data format valid during reproduction in the display device of the output unit,
the output format discriminating unit retrieves signals concerning the data format of the display device to discriminate the data format of the display device,
when the data format of the contents data is recognized to be a data format different from the data format in the display device, the processing unit converts, by changing a decoding speed of the contents data, a reproduction speed of the contents data to correspond to the data format in the display device before outputting to the output unit, and
if the contents data comprises audio contents, frequency characteristics of the audio contents is modified by a ratio that corresponds to a ratio of conversion of the reproduction speed.

12. A recording medium on which an information processing program is recorded, wherein
the information processing program according to claim 11 is recorded on the recording medium in a manner capable of being read out by a calculating unit.

13. A reproducing system, comprising:
an output unit that comprises a display device; and
an information processing device that processes contents data, which contains video contents, so that the contents data can be reproduced by the output unit or a DJ playback device that processes contents data, which contains video contents, so that the contents data can be reproduced by the output unit, wherein
the information processing device can be connected to an output unit which comprises a display device and processes contents data containing video contents to enable reproduction and comprises comprising: a contents data retrieving unit that retrieves the contents data; a data format discriminating unit that discriminates a data format of the contents data; an output format discriminating unit that discriminates a data format of the display device; and a processing unit that reproduces the contents data and outputs the contents data to the output unit,
the DJ playback device processes contents data that contains video contents to enable reproduction by an output unit that includes a display unit and comprises a manipulation unit that comprises a manipulation element provided rotatable by a rotation manipulation and outputs a manipulation signal that corresponds to manipulation of the manipulation element; a processing unit that reproduces the video contents and outputs the video contents to the output unit; a contents data retrieving unit that retrieves the contents data: a data format discriminating unit that discriminates a data format of the contents data: and an output format discriminating unit that discriminates a data format valid during reproduction in the display device of the output unit,
the output format discriminating unit retrieves signals concerning the data format of the display device to discriminate the data format of the display device,
when the data format of the contents data is recognized to be a data format different from the data format in the display device, the processing unit converts, by changing a decoding speed of the contents data, a reproduction speed of the contents data to correspond to the data format in the display device before outputting to the output unit, and
if the contents data comprises audio contents, frequency characteristics of the audio contents is modified by a ratio that corresponds to a ratio of conversion of the reproduction speed.
